(19) United States
(12) Patent Application Publication
(10) Pub. No.: US 2004/0167826 A1
(43) Pub. Date: Aug. 26, 2004

(54) Anonymous electronic funds transfer system and method, and anonymous shipping system and method

(76) Inventors: Kazutoshi Kobayashi, Yokohama (JP); Kiyoto Takahashi, Yokohama (JP); Hideaki Ohkoshi, Sagamihara (JP)

Correspondence Address: Edward A. Pennington, Esq., Swidler Berlin Shereff Friedman, LLP, Suite 300, 3000 K Street, N.W., Washington, DC, 20007-5116, US

(21) Appl. No.: 10/733,342

(22) Filed: Dec. 12, 2003

(30) Foreign Application Priority Data
Feb. 25, 2003 (JP) 2003-047798

(51) Int. Cl. G06F 17/60

(52) U.S. Cl. 705/26

(57) ABSTRACT

An anonymous electronic funds transfer system and method and anonymous shipping system and method are provided. A shopping mall server in an anonymous electronic funds transfer system comprises a reception unit operable to receive information about a product selected at a client terminal, a storage unit operable to store a monetary amount of a product provided on an online shopping website, and to store a purchase identifier that identifies a purchase of the product selected at the client terminal, a computing unit operable to calculate a payment sum for the product selected at the client terminal based on the monetary amount of the product stored in the storage unit, and, a transmission unit operable to, in response to designation of a credit company, send instructions to connect to a website of the designated credit company to the client terminal, the instructions including the purchase identifier and the payment sum, wherein the purchase identifier comprises a product name formed by encrypting a name of the product selected at the client terminal with a public key that is unique to the online shopping website.

### FIELD OF THE INVENTION

The present invention relates to an anonymous electronic funds transfer system and method and an anonymous shipping system and method. Specifically, the present invention relates to an anonymous electronic funds transfer system and method and an anonymous shipping system and method that can protect the privacy of customers when purchasing products through online shops.

### BACKGROUND OF THE INVENTION

Online shopping has become widespread in step with the development of the Internet. With online shopping, ensuring security and protecting privacy are highly emphasized.

FIG. 1 is a drawing that explains the flow of conventional online shopping. First, the customer connects to a shopping mall website through a network from the web browser of a client terminal and selects the product that the customer wishes to purchase (Step S101). Based on this selection, the price of the product to be purchased is sent to the client terminal from the shopping mall website (Step S102).

Next, the user supplies information such as the purchaser's name, address, and credit card number to the shopping mall website (Step S103). The shopping mall website supplies this information, such as the credit card number supplied from the client terminal, to the website of a credit company, and an inquiry is made regarding the credit number (Step S104).

At the website of the credit company, an inquiry is made regarding the credit card number supplied from the shopping mall website, and permission is granted regarding the purchase of the item using this credit card (Step S105). The client terminal of the user is notified of this permission through the shopping mall website (Step S106). This is followed by delivery of the product to the user, billing, and payment.

In the conventional system described above, from the perspective of ensuring security, methods that conceal credit card information from shopping mall (electronic mall) websites by establishing the input of credit card information independently from such websites, for example, have been disclosed (for example, Japanese Unexamined Patent Application Publication 2001-117976).

Moreover, in order to ensure security when data is transferred through networks in conventional Internet transactions, SSL (Secure Socket Layer) encrypted communication is used. By utilizing SSL encrypted communication technology, it is possible to prevent the leakage of information to 3^{rd} parties due to communication interception.

On the other hand, from the perspective of protecting the privacy of customers, even if data communication is performed using SSL encrypted communication technology between shopping mall websites and credit company websites, as shown in FIG. 1, there is still the possibility that information related to the privacy of customers will be leaked from the data source or recipient websites.

For example, information primarily related to products is stored in shopping mall websites, and information primarily related to customers is recorded in credit company websites. However, there is a possibility that each of the websites will inadvertently discover unnecessary information in the process of information exchange before and after settlement processing related to the purchase of products. For example, in the example of FIG. 1, the situation in which the credit company website obtains information related to the product purchased by the customer can be considered.

Moreover, in cases in which it is necessary to deliver a product purchased at a website to a customer, there are times in which information for the purpose of specifying the customer such as address, name, and e-mail address is supplied to the shopping mall website. It is necessary that the privacy of the customer be protected with regard to this information as well.

With the method described above, which conceals only credit card information, no consideration is given to the process of shipping the product to the customer through means other than communication lines, and from the perspective of information concealment, it does not have the edge over the “payment on delivery” shipping system, which is presently in widespread use.

When products are purchased using online shopping, it is desirable for privacy of customers to be protected in shopping mall websites and credit company or shipping company websites.

It is desirable to provide an anonymous electronic funds transfer system and method that can protect the privacy of customers in shopping mall websites and credit company websites.

Furthermore, it is desirable to provide an anonymous shipping system and method that can protect the privacy of customers in shopping mall websites and shipping company websites.

### SUMMARY OF THE INVENTION

The present invention solves the aforementioned problems by providing the capability to protect the privacy of customers in shopping mall websites and credit company or shipping company websites when products are purchased using online shopping, by providing an anonymous electronic funds transfer system and method that can protect the privacy of customers in shopping mall websites and credit company websites, and by providing an anonymous shipping system and method that can protect the privacy of customers in shopping mall websites and shipping company websites.

In one embodiment of the present invention, a shopping mall server in an anonymous electronic funds transfer system comprises a reception unit operable to receive information about a product selected at a client terminal, a storage unit operable to store a monetary amount of a product provided on an online shopping website, and to store a purchase identifier that identifies a purchase of the product selected at the client terminal, a computing unit operable to calculate a payment sum for the product selected at the client terminal based on the monetary amount of the product stored in the storage unit, and, a transmission unit operable to, in response to designation of a credit company, send instructions to connect to a website of the designated credit company to the client terminal, the instructions including the purchase identifier and the payment sum, wherein the purchase identifier comprises a product name formed by encrypting a name of the product selected at the client terminal with a public key that is unique to the online shopping website.

In one aspect of the present invention, the reception unit is further operable to receive settlement results including the purchase identifier from the website of the designated credit company.

In one embodiment of the present invention, a credit company server in an anonymous electronic funds transfer system comprises a reception unit operable to receive from a client terminal a payment sum, a purchase identifier that identifies a purchase of a product, and information specifying a credit card, a storage unit operable to store information specifying a credit card and a usage balance for the credit card corresponding to a customer, and to store a settlement identifier that identifies a settlement regarding the purchase of the product, the settlement associated with the customer having the information specifying the credit card received by the reception unit, a settlement unit operable to perform settlement and generated settlement results by selecting the credit card specified by the information received by the reception unit from among credit cards stored in the storage unit and comparing the selected usage balance with the payment sum received by the reception unit, and, a transmission unit operable to send the settlement results generated by the settlement unit, including the purchase identifier and the settlement identifier, to a shopping mall server that issued the purchase identifier, wherein the purchase identifier is a product name formed by encrypting a name of the product selected at the client terminal with a public key that is unique to the online shopping website.

In one aspect of the present invention, the settlement identifier is a customer name formed by encrypting a customer name corresponding to the information specifying the credit card supplied from the client terminal with a public key that is unique to the website of the credit company. The settlement unit is further operable to compare a password supplied from said client terminal with passwords stored in the storage unit to generate a comparison result, and the transmission unit is further operable to send the comparison result to the client terminal.

In one embodiment of the present invention, a shopping mall server in an anonymous electronic funds transfer system comprises a reception unit operable to receive information about a product selected at a client terminal, a storage unit operable to store a monetary amount and a size of the selected product, and to store a purchase identifier that identifies a purchase of the selected product, a computing unit operable to calculate a payment sum and shipping volume for the selected product based on the monetary amount and size of the product stored in the storage unit, and, a transmission unit operable to send instructions to connect to a website of a designated credit company, the instructions including the purchase identifier, the payment sum, and the shipping volume to the client terminal, in response to designation of a shipping company, wherein the purchase identifier is a product name formed by encrypting a name of the selected product with a public key that is unique to the online shopping website.

In one aspect of the present invention, the reception unit is further operable to receive shipping receipt results including the purchase identifier from a website of the designated shipping company.

In one embodiment of the present invention, a shipping company server in an anonymous electronic funds transfer system comprises a reception unit operable to receive a purchase identifier that identifies a purchase of a product, a payment sum and shipping volume relating to the product, and customer information relating to a purchaser of the product, from a client terminal, a storage unit operable to store a shipping identifier that identifies a shipment of the product, and, a transmission unit operable to send shipping reception results, including the purchase identifier and the shipping identifier, to a shopping mall server that issued the purchase identifier, wherein the purchase identifier is a product name formed by encrypting the name of the product selected at the client terminal with a public key that is unique to the online shopping website.

In one aspect of the present invention, the settlement identifier is a customer name formed by encrypting a customer name included in the customer information with a public key that is unique to a website of a credit company.

Through such an anonymous electronic funds transfer system, it is possible to selectively conceal all information other than that which is necessary for performing the essential roles of the online shopping website and credit company website (product provision and settlement processing).

### BRIEF DESCRIPTION OF THE DRAWINGS

FIG. 1 is a diagram explaining the flow of conventional online shopping.

FIG. 2 is a block diagram showing the anonymous electronic funds transfer system of the first embodiment of the present invention.

FIG. 3 is a diagram explaining the operation of the entire anonymous electronic funds transfer system of the first embodiment of the present invention.

FIG. 4 is a diagram illustrating an example of the product information used in the embodiments of the present invention.

FIG. 5 is a diagram illustrating an example of the credit company information used in the embodiments of the present invention.

FIG. 6 is a diagram illustrating an example of the HTML content showing the instruction to open a separate window in the first embodiment of the present invention.

FIG. 7 is a diagram illustrating an example of the credit card and password input screen in the first embodiment of the present invention.

FIG. 8 is a flow chart explaining the operation of shopping mall website W in embodiment 1 of the present invention, centered on web server 3.

FIG. 9 is a flow chart explaining the operation of the website of credit company C in the first embodiment of the present invention, centered on web server 23.

FIG. 10 is a diagram explaining the expanded function of the anonymous electronic funds transfer system of the first embodiment of the present invention.

FIG. 11 is a block diagram showing the anonymous shipping system of the second embodiment of the present invention.

FIG. 12 is a diagram explaining the operation of the entire anonymous shipping system of the second embodiment of the present invention.

FIG. 13 is a diagram illustrating an example of the HTML content showing the instruction to open a separate window in the second embodiment of the present invention.

FIG. 14 is a diagram illustrating an example of the name and address input screen in the second embodiment of the present invention.

FIG. 15 is a flow chart explaining the operation of shopping mall website W in the second embodiment of the present invention, centered on web server 45.

FIG. 16 is a flow chart explaining the operation of the website of shipping company T in the second embodiment of the present invention, centered on web server 65.

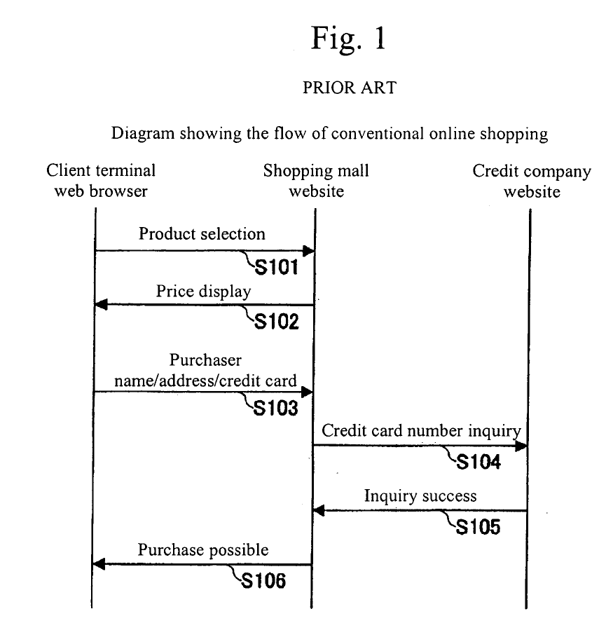

### DETAILED DESCRIPTION OF THE INVENTION

The embodiments of the present invention will hereafter be explained in detail with reference to the attached drawings.

In the first embodiment, the invention is created as an anonymous electronic funds transfer system for the purpose of avoiding the leakage of customer information in an online shopping website and a credit company website when purchasing products.

In the second embodiment, the invention is realized as an anonymous shipping system for the purpose of avoiding the leakage of customer information in an online shopping website and the website of shipping company T. Moreover, while these two systems can be created as mutually independent systems, they can also be created as a single system by linking them to one another.

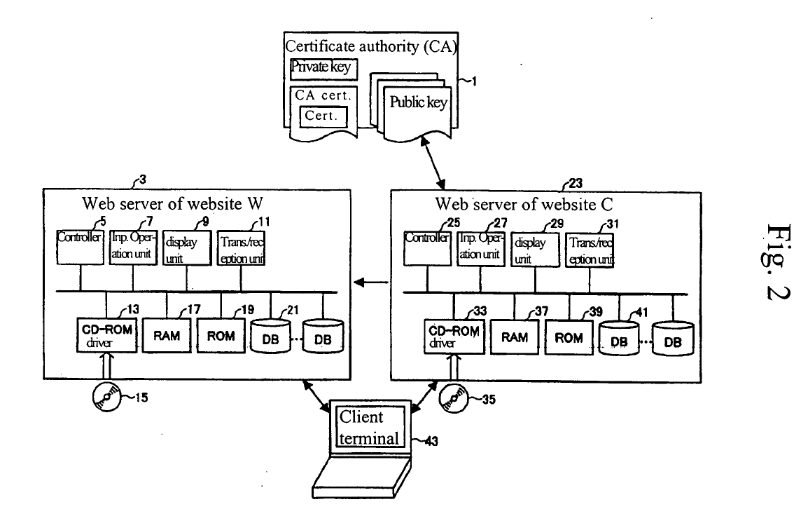

FIG. 2 is a block diagram showing the anonymous electronic funds transfer system of the first embodiment of the present invention. This anonymous electronic funds transfer system consists of certificate authority (CA) 1, web server 3 of shopping mall website W, web server 23 of the website of credit company C, and client terminal 43.

Certificate authority 1 issues a digital certificate (called a “server ID” hereafter) for SSL (Secure Socket Layer) compatible web servers. In this embodiment, this server ID verifies the existence of credit company C, which is the main business entity of the website, to the Internet user. SSL encrypted communication, which protects communication between the browser of web server 23 of credit company C and the browser of client terminal 43 or the browser of shopping mall web server 3, is thereby realized.

Because of this SSL encrypted communication, in this embodiment, credit company C applies for registration to a digital certificate issuing service for web servers provided by VeriSign Japan, for example. The above server ID is thus obtained in advance and installed in web server 23.

Moreover, a public key and a private key generated at web server 23 of credit company C are registered in certificate authority 1. Furthermore, route (CA) certificates are disclosed to client terminal 43 and shopping mall web server 3, and they are preinstalled in each of the web browsers.

Web server 3 of shopping mall website W (called web server 3 hereafter) provides an online shopping service to client terminal 43 through the Internet. This web server 3 consists of controller 5, input operation unit 7, display unit 9, transmission/reception unit 11, CD-ROM driver 13, RAM 17, ROM 19, and database (DB) 21.

Controller 5 is a device such as a microprocessor, and it controls the operation of the entire web server 3. For example, it controls (a) the communication of transmission/reception unit 11, including SSL encrypted communication, (b) the data writing and reading of RAM 17 and DB 21, and (c) the display of display unit 9. In particular, controller 5 uses a public key and private key unique to web server 3, which are stored in DB 21, to encrypt and decrypt the names of the products selected by client terminal 43.

Input operation unit 7 is a device such as a mouse or a keyboard, and it inputs and updates the web content, product catalog, and credit company information, which are stored in DB 21. Display unit 9 is a device such as a liquid crystal display (LCD), and it displays the details of data input and updates performed by input operation unit 7. Moreover, display unit 9 displays information such as the details of the exchange of data for the purpose of establishing SSL encrypted communication with the website of credit company C.

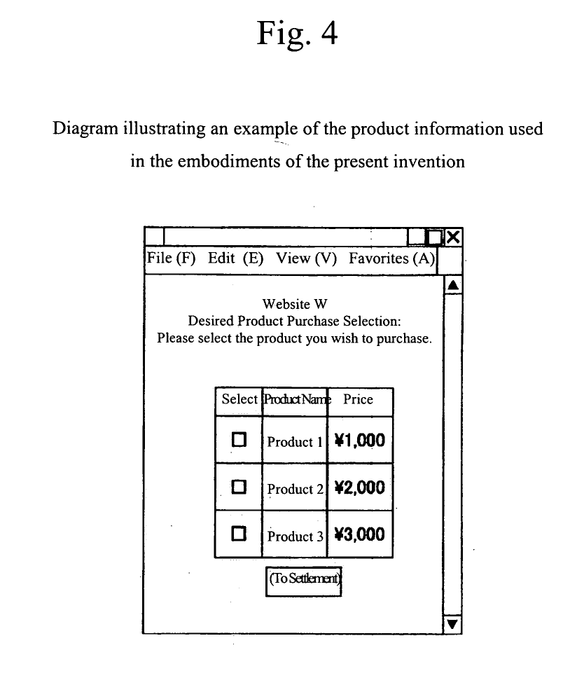

Transmission/reception unit 11 is a device such as a modem, and it performs data communication with client terminal 43 or web server 23. For example, it sends the content of the product information related to the online shopping service (refer to FIG. 4) to client terminal 43. Moreover, it establishes SSL encrypted communication with web server 23, and it receives the settlement results regarding the purchase of the products.

RAM 17 temporarily stores the data that is processed by controller 5. For example, it records information such as the total monetary amount of products selected by client terminal 43 and the names of the products, which are encrypted by controller 5. ROM 19 statically stores the program that orders the operation of web server 3 of the present invention.

DB 21 is a large-capacity storage device such as a magnetic disk, and it stores information such as web content, product catalog, and credit company information. The product catalog is a catalog of electronic information in which product names, product numbers, prices, and specifications, for example, are shown. Moreover, the credit company information consists of a simple company introduction including the company name, location, and service details.

Moreover, on one hand, a public key and a private key that are unique to web server 3 are stored in DB 21, and on the other hand, an application program (route certificate) for the purpose of establishing SSL encrypted communication with web server 23 is preinstalled in the web browser.

Furthermore, DB 21 stores a purchase table (not shown in the figure). This purchase table is created in response to the call for settlement, and the (encrypted) names and total monetary amount of the products selected by the customer are registered in accordance with a purchase identification number. This purchase identification number is a numbers for administrative use that is issued when the products are selected through client terminal 43.

Web server 23 of the website of credit company C (called web server 23 hereafter) performs settlement processing with regard to the purchase of the product selected by client terminal 43 through the Internet. This web server 23 consists of controller 25, input operation unit 27, display unit 29, transmission/reception unit 31, CD-ROM driver 33, RAM 37, ROM 39, and database (DB) 41.

Controller 25 is a device such as a microprocessor, and it controls the operation of the entire web server 23. For example, it controls (a) the communication of transmission/reception unit 31, including SSL encrypted communication, (b) the data writing and reading of RAM 37 and DB 41, and (c) the display of display unit 29. In particular, controller 25 uses a public key and a private key unique to web server 23, which are stored in DB 41, to encrypt and decrypt the name of the purchaser that purchased the products for which funds are to be transferred.

Input operation unit 27 is a device such as a mouse or a keyboard, and it inputs and updates information such as the web content and customer information stored in DB 41. Display unit 29 is a device such as a liquid crystal display (LCD), and it displays the details of data input and updates performed by input operation unit 27. Moreover, display unit 29 displays information such as the details of the exchange of data for the purpose of implementing SSL encrypted communication with client terminal 43 or web server 3.

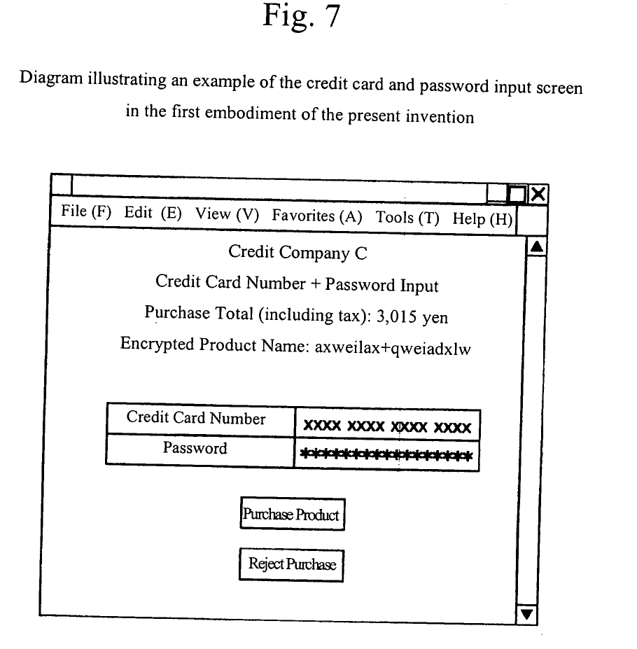

Transmission/reception unit 31 is a device such as a modem, and it performs data communication with client terminal 43 or web server 3. For example, transmission/reception unit 31 establishes SSL encrypted communication with client terminal 43 and sends the content of the credit card number and password input screen (refer to FIG. 7). Moreover, it establishes SSL encrypted communication with web server 3 and sends the settlement results regarding the purchase of the products.

RAM 37 temporarily stores the data that is processed by controller 25. For example, it records the credit card number and password supplied from client 43, as well as information such as the purchaser name, which is encrypted by controller 25. ROM 19 statically stores the program, for example, that orders the operation of web server 23 of the present invention.

DB 41 is a large-capacity storage device such as a magnetic disk, and it stores information such as web content and customer information. As for this customer information, information such as address, telephone number, e-mail address, place of employment information, credit card number, password, and balance of the card used, for example, is stored in accordance with a customer name. Moreover, on one hand, a public key and a private key unique to web server 23, which provides the function of this embodiment, are stored in DB 41, while on the other hand, server ID, which is supplied from certificate authority 1 for the purpose of SSL encrypted communication, is preinstalled in DB 41.

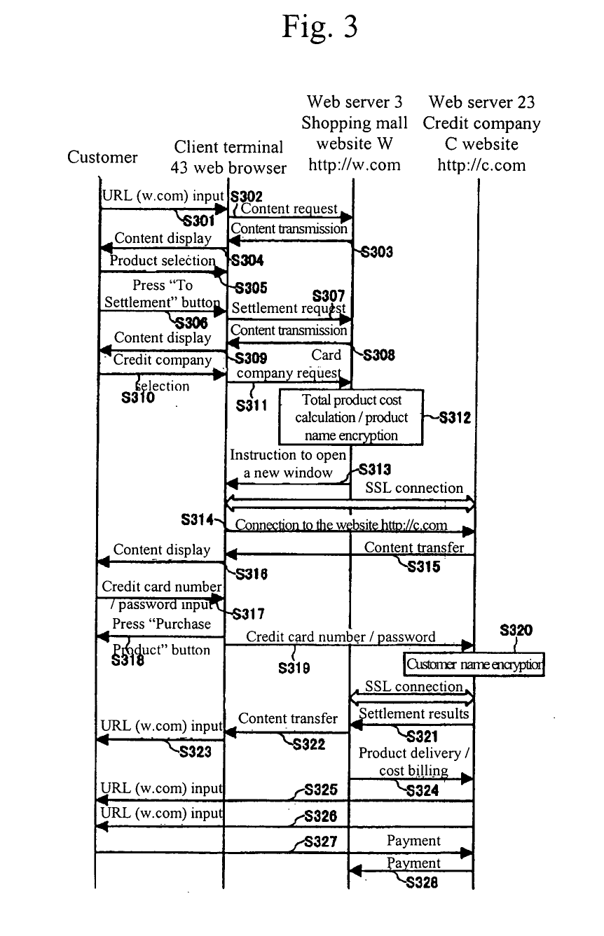

Furthermore, DB 41 stores a settlement table (not shown in the figure). The encrypted product names, the encrypted customer name, and the purchase identification number corresponding to a product receipt number are stored in this settlement table. This product receipt number is a number for administrative use that is issued to client terminal 43 by web server 23 when funds are received (FIG. 3, Step S319).

Client terminal 43 is a device such as a personal computer, a mobile communications terminal, or a PDA (Personal Digital Assistant), and it accesses web servers 3 and 23 through a web browser. Moreover, an application program (including a route certificate) for the purpose of establishing SSL encrypted communication with web server 23 is preinstalled in the browser of client terminal 43.

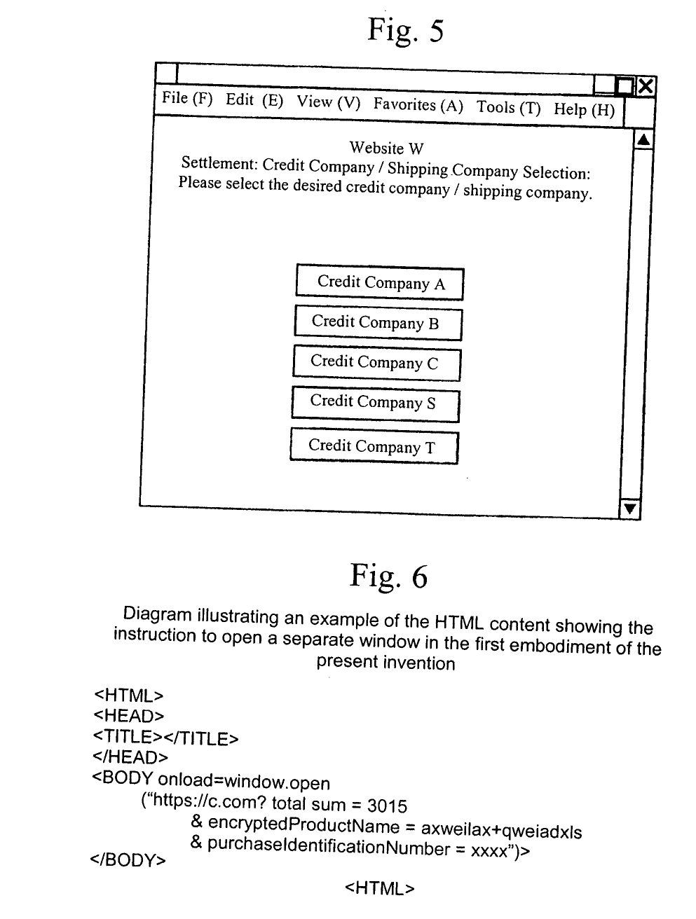

Moreover, a device such as a keyboard and a mouse for the purpose of selecting the desired product and the desired credit company (refer to FIGS. 4 and 5) is established in client terminal 43. Furthermore, a device such as a liquid crystal display for the purpose of displaying the content supplied from web servers 3 and 23 is established in client terminal 43.

FIG. 3 is a diagram that explains the operation of the entire anonymous electronic funds transfer system of this embodiment. Here, a succession of operations corresponding to the configuration shown in FIG. 2 is described.

First, the customer inputs http://w.com, the URL (Uniform Resource Locator) of online shopping mall website W, into the web browser of client terminal 43 (Step S301). In response to the URL input, client terminal 43 sends to website W a request for content for the purpose of displaying product information (Step S302).

In web server 3, controller 5 reads out a portion of the product catalog stored in DB 21 in response to the request for content received by transmission/reception unit 11. Next, transmission/reception unit 11 sends the product catalog read out by controller 5 to client terminal 43 (Step S303). The product information supplied from web server 3 is displayed at client terminal 43 (Step S304).

FIG. 4 is a diagram that illustrates an example of product information used in this embodiment. This product information is the entire product catalog or a portion of the product catalog stored in DB 21 that is read out from DB 21. In this embodiment, only the prices corresponding to product names are shown.

Products 1 through 3 provided by website W and their prices are displayed on this screen. The customer selects the desired product by clicking with the mouse on the selection field box established according to the product name and price (Step S305).

Moreover, a “To Settlement” button is shown on the screen shown in FIG. 4. After selecting the desired product, the customer presses this settlement button (Step S306). Client terminal 43 sends a request for settlement to web server 3 in response to the pressing of the settlement button (Step S307). The product name selected by the customer is included in this settlement request.

In web server 3, controller 5 reads out the information of the managing credit company stored in DB 21 in response to the request for settlement received by transmission/reception unit 11. Next, transmission/reception unit 11 forwards the credit company information read out by controller 5 to client terminal 43 (Step S308). The information of the credit company supplied from web server 3 is displayed at client terminal 43 (Step S309).

FIG. 5 is a diagram that illustrates an example of the credit company information used in this embodiment. This credit company information is the entire credit company information or a portion of the credit company information stored in DB 21 that is read out from DB 21. Here, buttons corresponding to the names of managing credit companies A, B, and C are simultaneously displayed, and buttons corresponding to managing shipping companies S and T are also simultaneously displayed. This shipping company S or T is selected with the anonymous shipping system of the second embodiment, which will be described later.

The customer presses the button corresponding to the desired credit company (Step S310). The web browser of client terminal 43 sends a request for connection to the selected credit company to web server 3 in response to the pressing of the credit company button (Step S311).

In web server 3 of website W, controller 5 refers to the product catalog stored in DB 21 and calculates the total monetary amount from the prices corresponding to the product names included in the settlement request supplied from client terminal 43 in Step S307.

Moreover, controller 5 reads out a public key unique to web server 3, which provides the function of this embodiment, from DB 21, and it encrypts the product names contained in the settlement request with this public key (Step S312). Because the product names are encrypted, the credit company is not able to know what the customer has purchased, so the privacy of the customer is protected.

Furthermore, controller 5 registers the details of the current purchase event in the purchase table stored in DB 21. Specifically, it issues a purchase identification number and registers the product names encrypted in Step S312 in the purchase table in correspondence with this purchase identification number.

Controller 5 sends an instruction to the web browser of client terminal 43 to open a window corresponding to the website (http://c.com) of credit company C, which differs from shopping mall website W (http//w.com). Based on this instruction, client terminal 43 establishes SSL encrypted communication with web server 23, which corresponds to credit company C selected in Step S310.

FIG. 6 is a diagram that illustrates an example of the HTML content showing the instruction to open a separate window in this embodiment. This HTML content is the instruction sent in Step S313.

In particular, the instruction “window. open( )” that opens the window is shown in the body <BODY> of the text, and the website (http://c.com) corresponding to the new window and the total monetary amount “3015 yen” supplied in Step S312, the encrypted product names, “axweilax+qweiadxlw,” and the issued purchase identification number “xxxx” are included in this instruction.

The procedure of establishing SSL encrypted communication will be explained briefly. First, an application program for the purpose of establishing SSL encrypted communication, which is preinstalled in the browser, is started at client terminal 43. Next, client terminal 43 sends an access request to web server 23. A list of the usable encryption systems, etc. is included in this access request. Web server 23 then sends a reply to client terminal 43 in response to this access request. The encryption system to be used, which is determined by web server 23, is included in this reply. Next, web server 23 sends a server certificate to client terminal 43. All of the certificates (digital ID's) from the web server itself to the highest route CA are included in this certificate.

Next, keys are exchanged. Client terminal 43 receives the digital ID supplied from web server 23 and generates random number data, which is responsible for generating the keys used to encrypt data in subsequent communications. This data is sent to web server 23 after it is encrypted with a server public key obtained from the digital ID of web server 23. After the above process is complete, the transmission of data that has been encrypted/compressed commences based on a system agreed upon by both parties in advance.

Client terminal 43 requests web server 23 of credit company C for the content of the credit card number and password input screen (Step S314). The details of the HTML content received in Step S313 (total monetary amount, encrypted product name, purchase identification number), for example, are included in this request.

Controller 25 of web server 23 reads out the content for the input of the credit card information stored in DB 41. Controller 25 incorporates the total monetary amount and encrypted product names contained in the HTML content received in Step [S] 314 into this content that is read out, and it then sends the content to client terminal 43 in accordance with the SSL encrypted communication system (Step S315). A window corresponding to the website of credit company C is newly displayed at client terminal 43 through the web browser (Step S316).

FIG. 7 is a diagram that illustrates an example of the credit card number and password input screen in this embodiment. The purchase total (including tax), the encrypted product names, credit card number and password input boxes, as well as a button that indicates the desire to purchase the product and a button that rejects the purchase of the products, are established on this screen.

Using input operation unit 27, the customer inputs the credit card number and password (Step S317) and presses the purchase button (Step S318). In accordance with the SSL encrypted communication method, client terminal 43 sends the credit card number and password inputted in Step S317 to web server 23 (Step S319).

Controller 25 of web server 23 processes the settlement according to the credit card number and password supplied from client terminal 43. Specifically, controller 25 refers to the customer information stored in DB 41 and compares the balance corresponding to the credit card number supplied from client terminal 43 with the total monetary amount contained in the HTML content (refer to FIG. 6) received in Step S114, and thereby settles whether or not purchase is possible.

Moreover, controller 25 refers to DB 41 and encrypts the customer name corresponding to the credit card number supplied from client terminal 43 with the public key that is unique to web server 23, which is stored in DB 41. Because the name of the customer is encrypted, website W is unable to know who has purchased the products that were purchased in the current purchase event, so the privacy of the customer is protected.

Furthermore, in the case in which the results of settlement were successful (in other words, “OK”), controller 25 issues a product receipt number and registers the details of the current settlement event in the settlement table stored in DB 41 (Step S320).

Next, transmission/reception unit 31 of web server 23 establishes SSL encrypted communication with web server 3 of shopping mall website W in response to the instruction of controller 25. This communication is established with the same procedures as described after Step S313, with the exception that web server 3 takes the place of the previous client terminal 43.

In response to the commencement of SSL encrypted communication, controller 25 of web server 23 notifies web server 3 of the settlement results in accordance with the SSL encryption communication system (Step S321). In addition to the actual settlement result (for example, “OK/NO,” etc.), the product receipt number previously registered in the settlement table, the encrypted product names, the encrypted customer name, and the purchase identification number are included in these settlement results.

Web server 3 forwards the settlement results supplied from web server 23 to client terminal 43 (Step S322). Client terminal 43 displays the settlement results in a window corresponding to website W (Step S323). Controller 25 then terminates SSL encrypted communication.

After this, in the case in which the product is electronic information that can be transferred to the customer through a communications line such as the Internet, for example, controller 5 of web server 3 refers to the purchase table of DB 21 and decrypts the encrypted product names corresponding to the purchase identification number contained in the settlement results that were sent in Step S321 with the private key that is unique to web server 3, which is stored in DB 21.

Through this decryption, the corresponding products are packaged by a contracted agent, for example. Labels showing the product receipt number, the encrypted product names, and the encrypted customer name are attached to the products, and they are delivered to credit company C. At this time, a request for the cost of the products is made to web server 23 by web server 3 (Step S324).

At the website of credit company C, the encrypted customer name shown on the received product labels is inputted through input operation unit 27. Controller 25 obtains the customer name by decrypting this inputted encrypted customer name with the private key unique to web server 23, which is stored in DB 41.

Next, controller 25 refers to the customer information stored in DB 41, and it forwards the product to the registered e-mail address corresponding to this customer name (Step S325). Credit company C bills the customer for the cost of the products by mail, for example (Step S326). The customer pays the cost of the products in response to the bill of credit company C (Step S327). In response to the customer's payment of the cost of the products, credit company C pays an expense to the corporation or individual that administers website W (Step S328).

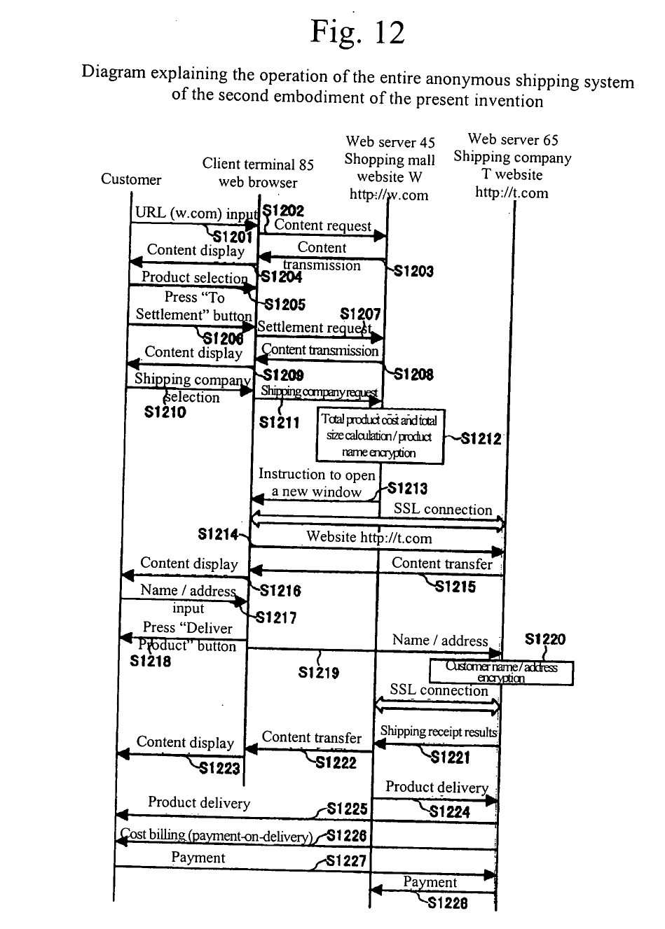

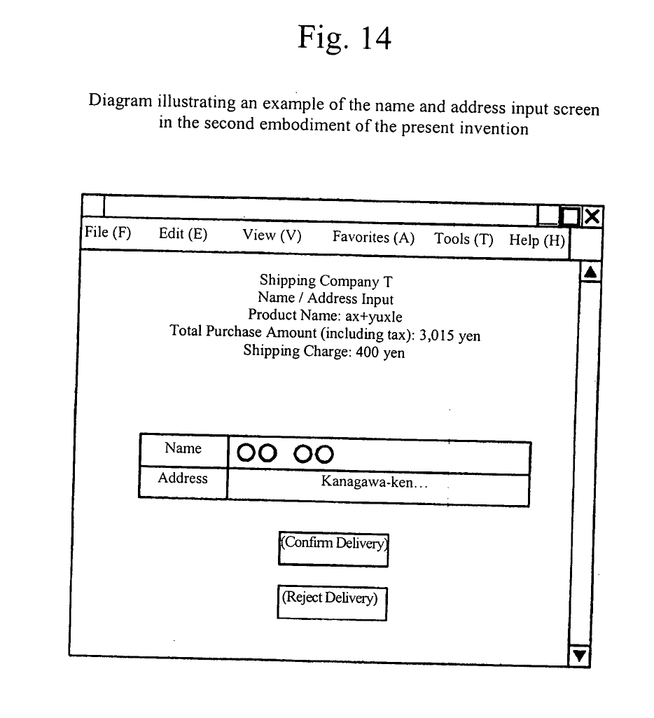

Moreover, in the case in which the product is an item other than the aforementioned electronic information, it is possible, for example, to link the operation of this system to that of the anonymous shipping system of the second embodiment (Step S1208 of FIG. 12), which will be described later. Specifically, a shipping company (refer to FIG. 5) is selected and the name and address of the addressee (refer to FIG. 14) are sent to the selected shipping company, whereby the system proceeds to shipping reception processing. In this case, the cost maybe be claimed through payment on delivery, or it may be claimed by credit company C separately by mail.

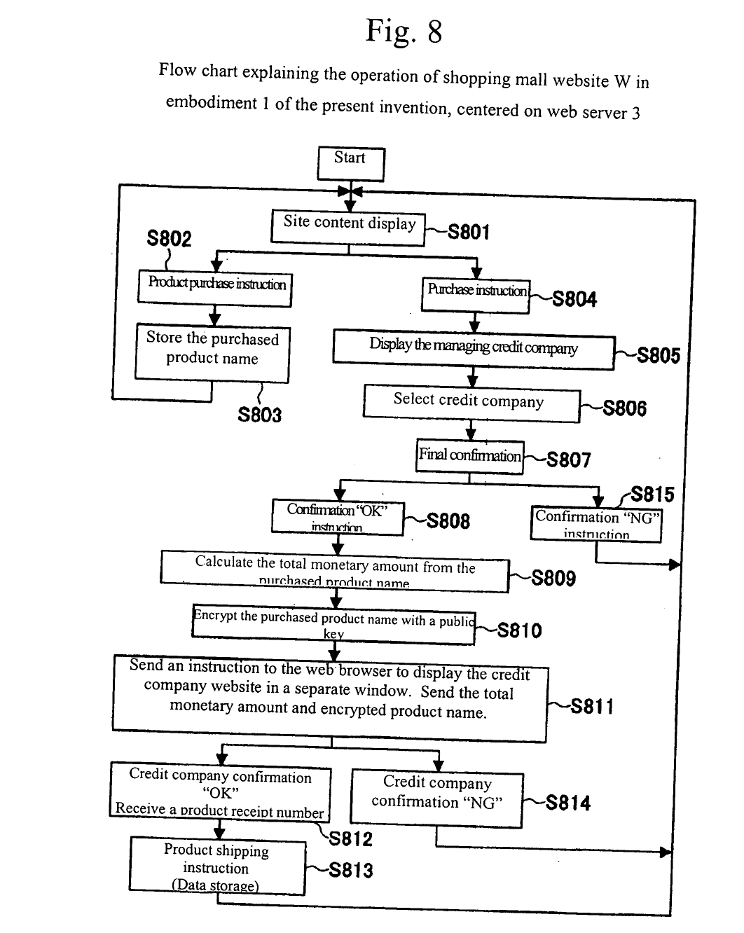

FIG. 8 is a flow chart that explains the operation of shopping mall website W in this embodiment, centered on web server 3. Here, the link with the web browser of client terminal 43 or web server 23 will be explained.

First, product information (refer to FIG. 4) is provided to client terminal 43 by web server 3 and displayed (Step S801). Next, in sequential response to the selection of desired products (Step S802), the selected product names are stored in RAM 17 (Step S803).

Next, when the instruction to purchase is received (Step S804), credit company information is read out and sent to client terminal 43. Through this, the credit company information (refer to FIG. 5) is displayed at client terminal 43 (Step S805).

Next, when a credit company is selected at client terminal 43 (Step S806), a small window separate from the window shown in FIG. 5 is displayed, for example, and the advisability of the selection is finally confirmed (Step S807).

In the final confirmation, when a confirmed “OK” instruction is received from client terminal 43 (Step S808), the product catalog is consulted, the price shown corresponding to the product names stored in Step S803 is totalled, and the total monetary amount of products purchased is calculated (Step S809). Moreover, the products stored in Step S803 are encrypted with a public key that is unique to web server 3 (Step S810).

A purchase identification number is then issued, and this purchase identification number and the product names encrypted in Step S810 are handled and registered in the purchase table. Moreover, when a confirmed “NG”—in other words, an instruction to cancel—is received from client terminal 43 (Step S815), the system returns to Step S801.

Next, an instruction that causes the website of credit company C that was selected in Step S806 to be displayed in a separated window is sent to client terminal 43. In this embodiment, this instruction is sent as HTML content containing the total monetary amount calculated in Step S809, the product names encrypted in Step S810, and the purchase identification number (refer to FIG. 6) (Step S811).

Next, after SSL encrypted communication is established with web server 23, a settlement notification is received. In the case in which the received settlement results indicate “OK” (Step S812), the purchase identification number contained in the settlement results is obtained.

As described above, in the case in which the product is electronic information, for example, the encrypted product name that corresponds to this obtained purchase identification number is decrypted from among encrypted product names stored in the purchase table. In response to this decryption, the corresponding product is delivered to credit company C by an agent contracted by website W (Step S813). Moreover, in the case in which the settlement results indicate “NO” (Step S814), the system returns to Step S801.

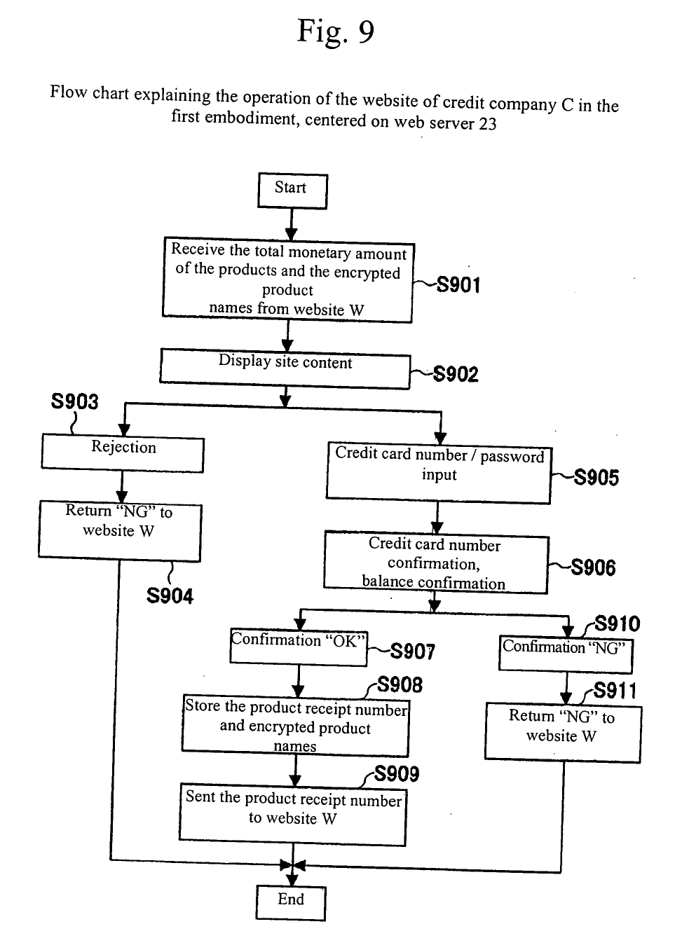

FIG. 9 is a flow chart that explains the operation of the website of credit company C in this embodiment, centered on web server 23. Here, the link with the web browser of client terminal 43 or web server 3 will be explained.

First, after SSL encrypted communication has been established, the total monetary amount, the encrypted product names, and the purchase identification number are received from client terminal 43 (Step S901). In response to this reception, the content of the credit card and password input screen shown in FIG. 7 are created. The input screen content is then displayed at client terminal 43 (Step S902).

Next, when the button that rejects the purchase (refer to FIG. 7) is pressed—in other words, when the execution of settlement processing is rejected by the customer (Step S903)—a message indicating “NG” is sent to web server 3 of website W, and SSL encrypted communication is terminated (Step S904).

Moreover, when the button to purchase the product (refer to FIG. 7) is pressed, the credit card number and password are received (Step S905).

Next, settlement processing is executed. Specifically, the purchaser information is consulted and the received credit card number is confirmed, and the balance corresponding to this card number is also confirmed (Step S906). SSL encrypted communication is then established with web server 3.

In the case in which the results of settlement indicate “OK” (Step S907), the details of the current settlement event are registered in the settlement table (Step S908), and information such as the product receipt number is sent along with the settlement results (Step S909). Moreover, in the case in which the results of settlement indicate “NO” (Step S910), a message indicating “NG” is sent as the settlement results (Step S911).

To summarize the system in this embodiment, web server 3 has, in particular, DB 21, controller 5, and transmission/reception unit 11. DB 21 stores the encryption key that is unique to shopping mall website W, as well as the names and prices of products provided at this website W. Transmission/reception unit 11 receives a request for settlement regarding the purchase of products from client terminal 43.

Controller 5 refers to DB 21 and computes the total monetary amount of purchased products from the product names contained in this settlement request, and it encrypts the product names included in this settlement request with a public key stored in DB 21. Moreover, when a designation of credit company C is received by transmission/reception unit 11, controller 5 instructs this designated credit company to execute the settlement processing of the product purchase. In response to the instruction from controller 5, transmission/reception unit 11 sends an instruction to client terminal 43 to connect to the website of the designated credit company C, including the encrypted product names, the total monetary amount of purchased products, and a purchase identification number.

Here, in the aforementioned embodiment, encrypted product names are registered in DB 21 (purchase table) for every purchase event in correspondence with purchase identifiers (Step S312 of FIG. 3), and all of this information is sent to client terminal 43 (Step S313 in FIG. 3). The purchase table is then consulted at web server 3, and the encrypted product names corresponding to the purchase identification number contained in the settlement results from web server 23 are decrypted.

In contrast to this, as another embodiment of this invention, it is of course possible to send only the purchase identification number after registration in the purchase table in Step S312. It is essential that it be impossible to determine the correspondence of this purchase identification number with information related to products from the web server 23 side. Therefore, as a special case, the actual encrypted product names may be sent in place of this purchase identification number. In this case, taking into consideration subsequent decryption processing, it is preferable for web server 3 to be aware in advance of the data positions of the encrypted product names in the details of the settlement results received in Step S321.

In any case, it should be possible to determine the purchase event to which the received settlement results correspond from the web server 3 side. Therefore, an identifier (for example, a symbol string) that identifies the purchase of the product should be stored in the purchase table in accordance with the product selected through client terminal 43.

Moreover, the number of products purchased does not restrict the present invention. Therefore, controller 5 of web server 3 calculates the payment amounts for 1 or multiple products selected through client terminal 43.

To further summarize the system in this embodiment, web server 23 has, in particular, DB 41, transmission/reception unit 31, and controller 25. DB 41 stores the encryption key that is unique to the website of credit company C, as well as the credit card number and usage balance corresponding to the customer. Transmission/reception unit 31 receives the product names encrypted with the encryption key that is unique to the online shopping website W, the total monetary amount of the purchased products, the purchase identification number, and the credit card number from client terminal 43.

Controller 25 refers to the customer information stored in DB 41 and executes settlement processing based on a comparison of the usage balance corresponding to the credit card number received by transmission/reception unit 31 with the received total monetary amount of purchased products. Moreover, controller 25 refers to DB 41 and encrypts the customer name corresponding to the credit card number received by transmission/reception unit 31 with the public key stored in DB 41. Transmission/reception unit 31 sends the settlement results, including the encrypted product names, the encrypted customer name, the purchase identification number, and the product receipt number, to online shopping website W.

Combining this with the other embodiment with respect to web server 3 described above, instead of encrypted product names, transmission/reception unit 31 may receive identifiers that identify the purchase of products coordinated with products selected through client terminal 43.

Moreover, in the aforementioned embodiment, the encrypted customer name (and purchase identification number) is registered in DB 41 (settlement table) for every settlement event in correspondence with the product receipt number (Step S320 in FIG. 3), and the information of both this product receipt number and the encrypted customer name is sent to web server 3 (Step S321 in FIG. 3). The settlement table is then consulted at web server 23, and the encrypted customer name corresponding to the product receipt number shown on the labels of the products sent from web server 3 is decrypted.

In contrast to this, as another embodiment of this invention, it is of course possible to send only the product receipt number after registration in the settlement table in Step S320. It is essential that it be impossible to determine the correspondence of this product receipt number to the information that specifies the customer from the web server 3 side. Therefore, as a special case, the actual encrypted customer name may be sent in place of this product receipt number.

In any case, it should be possible to determine the settlement event to which a received product corresponds from the web server 23 side. Therefore, an identifier (for example, a symbol string) that identifies the settlement regarding the purchase of the product should be stored in the settlement table in accordance with the customer having the credit card number received in Step S319.

In this way, the information regarding products to be purchased is encrypted with the public key of web server 3 of website W that has the product information, and it is only possible to decrypt the code with the private key of this site W, so the information is concealed from the website of credit company C. Moreover, the information of the customer that purchases the products is encrypted with the public key of web server 23 of credit company C, and it is only possible to decrypt the code with the private key of this site, so the information is concealed from website W. It is therefore possible to perform a series of electronic funds transfers by obtaining only the information that is necessary for the processing that should be executed at each site.

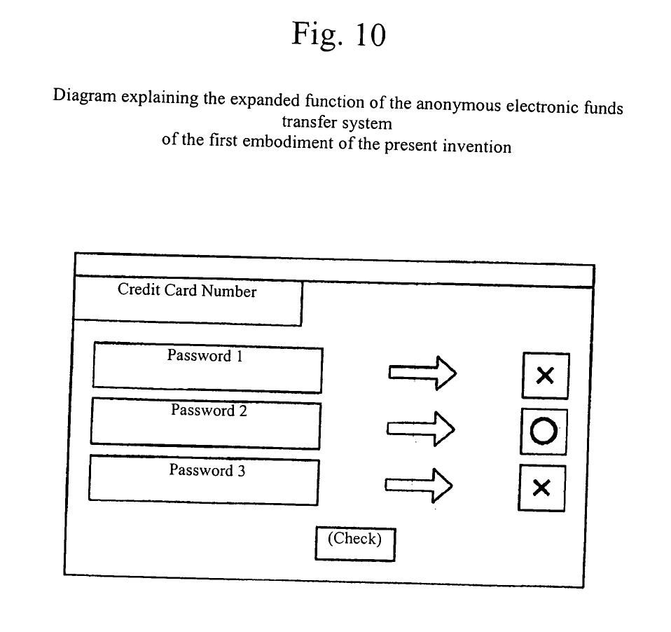

Next, the expansion of the function of this embodiment will be explained with reference to FIG. 10. FIG. 10 is a diagram explaining the expanded 'function of the anonymous electronic funds transfer system of the first embodiment of the present invention. This figure shows, for example, the screen that is displayed at client terminal 43 between Steps S316 and S317 shown in FIG. 3 of the first embodiment. This screen authenticates the credit companies used.

In the first embodiment, SSL encrypted communication is established between client terminal 43 and web server 23. In the case in which this SSL encrypted communication commences, it is possible to recognize the customer of client terminal 43 from web server 23. In other words, it is possible for web server 23 to recognize the password of the customer before receiving the password and credit card number in Step S317.

DB 21 stores in advance the content of the screen shown in FIG. 10. Input boxes for 3 types of passwords 1, 2, and 3 are established in this content, and boxes in which the results of checking the passwords from credit company C are displayed are established in correspondence with each of these input boxes.

When the screen shown in FIG. 10 is displayed at client terminal 43, the customer inputs the 3 types of passwords and clicks the check boxes. Controller 25 of web server 23 compares each of the 3 types of passwords received by transmission/reception unit 31 with the passwords of the corresponding customer in the customer information stored in DB 41, and generates comparison results such as “O” or “X.” These comparison results are sent to client terminal 43 by transmission/reception unit 31, and they are displayed in the boxes that display the password checking results shown in FIG. 10.

Through this function, the customer inputs the 3 types of passwords in a pattern such that, for example, they are “all correct,” they are “all incorrect,” and “1 is correct.” Furthermore, in the case in which the anticipated results are not obtained with regard to the checking results, which come as the response of web server 23, it is possible to determine that the reliability of credit company C is low and to abandon further procedures.

Moreover, the types of passwords that are inputted into client terminal 43 do not restrict the present invention. Therefore, controller 25 of web server 23 compares 1 or multiple passwords supplied from the client terminal with the passwords of the corresponding customer stored in DB 41, and it generates comparison results for each comparison.

Next, the anonymous shipping system of the second embodiment of the present invention will be explained. As described at the end of FIG. 3, in the case in which the product is an item other than electronic information, this anonymous shipping system 1) can be implemented as a shipping system accommodating a payment-after-delivery system that is linked after settlement processing by credit company C, and 2) can be implemented as a system accommodating a payment-on-delivery system or a payment-after-delivery system that does not rely on settlement processing by credit company C.

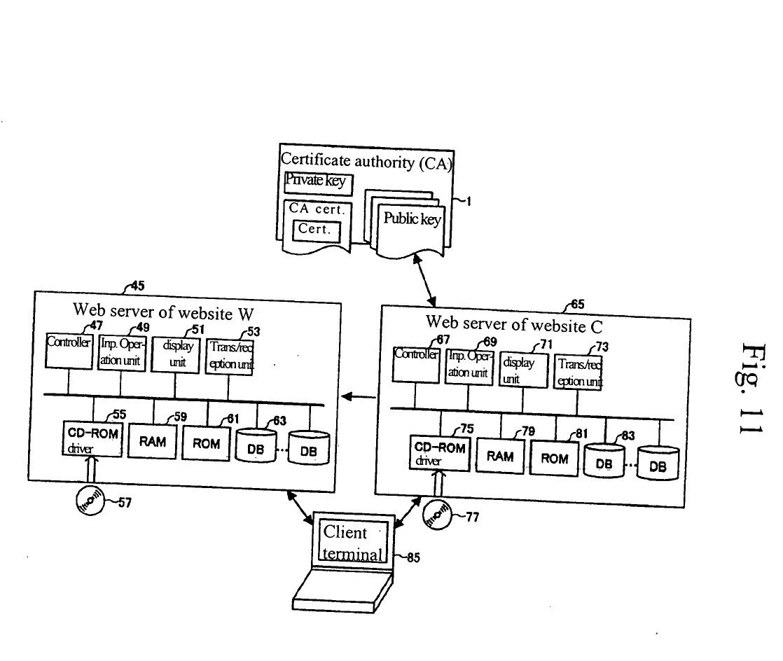

FIG. 11 is a block diagram showing the anonymous shipping system of the second embodiment of the present invention. This anonymous shipping system consists of the same certificate authority 1 as in the first embodiment, web server 45 of shopping mall website W, and web server 65 of the website of shipping company T, and client terminal 85.

Web server 45 of shopping mall website W (called web server 45 hereafter) provides client terminal 85 with an online shopping service through the internet. This web server 45 consists of controller 47, input operation unit 49, display unit 51, transmission/reception unit 53, CD-ROM driver 55, RAM 59, ROM 61, and database (DB) 63.

Controller 47 is a device such as a microprocessor, and it controls the operation of the entire web server 45. For example, it controls (a) the communication of transmission/reception unit 53, including SSL encrypted communication, (b) the data writing and reading of RAM 59 and DB 63, and (c) the display of display unit 51. In particular, controller 47 uses a public key and private key unique to web server 45, which are stored in DB 63, to encrypt and decrypt the names of the products selected by client terminal 85.

Input operation unit 49 is a device such as a mouse or a keyboard, and it inputs and updates the web content, product catalog, and shipping company information, which are stored in DB 63. Display unit 51 is a device such as a liquid crystal display (LCD), and it displays information such as the details of data input and updates performed by input operation unit 49. Moreover, display unit 51 displays information such as the details of the exchange of data for the purpose of establishing SSL encrypted communication with the website of shipping company T.

Transmission/reception unit 53 is a device such as a modem, and it performs data communication with client terminal 85 or web server 65. For example, it sends the content of the product information related to the online shopping service (refer to FIG. 4) to client terminal 85. Moreover, it establishes SSL encrypted communication with web server 65, and it receives the receipt results regarding the shipping of the products.

RAM 59 temporarily stores the data that is processed by controller 47. For example, it stores information such as the total size and total monetary amount of the products selected through client terminal 85, as well as the product names, which are encrypted by controller 47. ROM 61 statically stores the program, for example, that orders the operation of web server 45 of shopping mall site W in the present invention.

DB 63 is a large-capacity storage device such as a magnetic disk, and it stores information such as web content, product catalog, and shipping company information. The product catalog is a catalog of electronic information in which product names, product numbers, prices, and specifications, for example, are shown. Moreover, the shipping company information consists of a simple company introduction including the company name, location, and service details.

Moreover, on one hand, a public key and a private key that are unique to web server 45 are stored in DB 63, and on the other hand, an application program (route certificate) for the purpose of establishing SSL encrypted communication with web server 45 is preinstalled in the web browser.

Furthermore, DB 63 stores a purchase table (not shown in the figure). This purchase table is created in response to the request for shipping, and the (encrypted) names and total monetary amount of the products selected by the customer are registered in accordance with a purchase identification number. This purchase identification number is a number for administrative use that is issued when the products are selected through client terminal 43 in the online shopping service.

Web server 65 of the website of shipping company T (called web server 65 hereafter) performs procedures for the purpose of shipping the products selected by client terminal 43 through the internet. Moreover, shipping companies include delivery agents that deliver products using so-called “bike messengers.” Web server 65 consists of controller 67, input operation unit 69, display unit 71, transmission/reception unit 73, CD-ROM driver 75, RAM 79, ROM 39, and database (DB) 83.

Controller 67 is a device such as a microprocessor, and it controls the operation of the entire web server 65. For example, it controls (a) the communication of transmission/reception unit 73, including SSL encrypted communication, (b) the data writing and reading of RAM 79 and DB 83, and (c) the display of display unit 71. In particular, controller 67 uses a public key and a private key unique to web server 65, which are stored in DB 83, to encrypt and decrypt the name and address of the purchaser that purchased the products.

Input operation unit 69 is a device such as a mouse or a keyboard, and it inputs and updates information such as the web content and customer information stored in DB 83. Display unit 71 is a device such as a liquid crystal display (LCD), and it displays the details of data input and updates performed by input operation unit 69. Moreover, display unit 71 displays information such as the details of the exchange of data for the purpose of implementing SSL encrypted communication with client terminal 85 or web server 45.

Transmission/reception unit 73 is a device such as a modem, and it performs data communication with client terminal 85 or web server 45. For example, transmission/reception unit 73 establishes SSL encrypted communication with client terminal 85 and sends the content of the name and address input screen (refer to FIG. 14). Moreover, it establishes SSL encrypted communication with web server 45 and sends the receipt results regarding the shipping of the products.

RAM 79 temporarily stores the data that is processed by controller 67. For example, it stores the name and address supplied from client terminal 85, as well as information such as the name and address that are encrypted by controller 67. ROM 81 statically stores the program, for example, that orders the operation of web server 65 of shipping company T in the present invention.

DB 83 is a large-capacity storage device such as a magnetic disk, and it stores information such as web content. Moreover, on one hand, a public key and a private key unique to web server 65, which provides the function of this embodiment, are stored in DB 83, while on the other hand, a server ID, which is supplied from certificate authority 1 for the purpose of SSL encrypted communication, is preinstalled in DB 83.

Furthermore, DB 83 stores a shipping table (not shown in the figure). The encrypted product names, the encrypted addressee name and address, and the purchase identification number corresponding to a product shipping number are stored in this shipping table. This product shipping number is a number for administrative use that is issued to client terminal 85 by web server 65 when the shipment is received (Step S1219 in FIG. 12).

Client terminal 85 is a device such as a personal computer, a mobile communications terminal, or a PDA (Personal Digital Assistant), and it accesses web servers 45 and 65 through a browser. This client terminal 85 has the same structure as client terminal 43 in the first embodiment.

FIG. 12 is a diagram that explains the operation of the entire anonymous shipping system of this embodiment. Here, a succession of operations is described based on the configuration shown in FIG. 11.

First, the customer inputs http://w.com, the URL of online shopping mall website W, into the web browser of client terminal 85 (Step S1201). In response to the URL input, client terminal 85 sends to website W a request for content for the purpose of displaying product information (Step S1202).

In web server 45 of website W, controller 47 reads out a portion of the product catalog stored in DB 63 in response to the request for content received by transmission/reception unit 53. Next, transmission/reception unit 53 sends the product catalog read out by controller 47 to client terminal 85 (Step S1203).

The product information supplied from web server 45 is displayed at client terminal 85 (Step S1204). As shown in FIG. 4, the customer selects the desired products by clicking with the mouse on the selection field boxes corresponding to the product names and prices (Step S1205).

A “To Settlement” button is shown on the screen shown in FIG. 4. After selecting the desired products, the customer presses this settlement button (Step S1206). Client terminal 85 sends a request for settlement to web server 45 in response to the pressing of the settlement button (Step S1207). The names of the products selected by the customer are included in this settlement request.

In web server 45, controller 47 reads out the information of the managing shipping company stored in DB 63 in response to the request for settlement received by transmission/reception unit 53. Next, transmission/reception unit 53 forwards the shipping company information read out by controller 47 to client terminal 85 (Step S1208). The information of the shipping company supplied from web server 45 is displayed at client terminal 85 (Step S1209). As shown in FIG. 5, the customer presses the button corresponding to the desired shipping company (Step S1210). Client terminal 85 sends a request to web server 45 to connect to the selected shipping company in response to the pressing of the shipping company button (Step S1211).

In web server 45, controller 47 refers to the product catalog stored in DB 63 and calculates both the total monetary amount from the prices corresponding to the product names included in the settlement request supplied from client terminal 85 in Step S1207 and the total size from the dimensions corresponding to these product names.

Moreover, controller 47 reads out a public key unique to web server 45, which provides the function of this embodiment, from DB 63, and it encrypts the product names contained in the settlement request with this public key (Step S1212). Because the product names are encrypted, the credit company is not able to know what the customer has purchased, so the privacy of the customer is protected.

Furthermore, controller 47 registers the details of the current purchase event in the purchase table stored in DB 63. Specifically, it issues a purchase identification number and registers the product names encrypted in Step S1212 in the purchase table in correspondence with this purchase identification number.

Controller 47 sends an instruction to the web browser of client terminal 85 to open a window corresponding to the website (http://t.com) of shipping company T, which differs from shopping mall website W (http://w.com). Based on this instruction, client terminal 85 establishes SSL encrypted communication with web server 65, which corresponds to shipping company T selected in Step S1210. The procedures of this establishment are the same as the procedures between client terminal 43 and web server 23 of credit company C that were explained in the first embodiment.

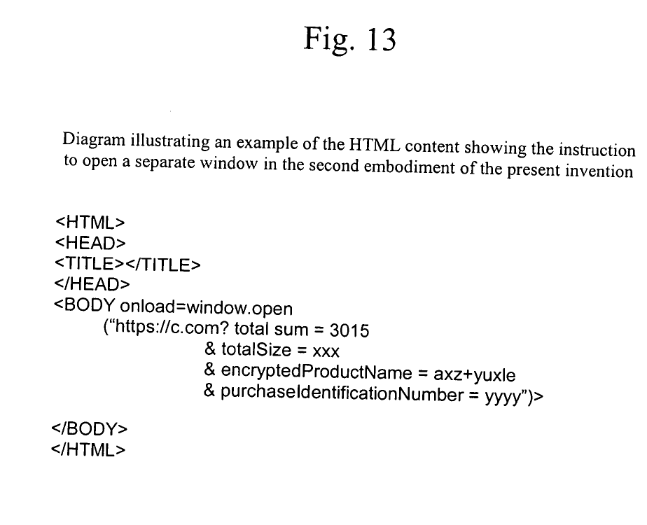

FIG. 13 is a diagram that illustrates an example of the HTML content showing the instruction to open a separate window in this embodiment. This HTML content is the instruction sent in Step S1213.

In particular, the instruction “window. open( )” that opens the window is shown in the body <BODY> of the text, and the website (http://t.com) corresponding to the new window, the total monetary amount “3015 yen” and the total size “xxx” supplied in Step S1212, the encrypted product name “axweilax+qweiadxlw,” and the issued purchase identification number “yyyy” are included in this instruction.

Client terminal 85 requests web server 65 of shipping company T for the content of the name and address input screen (Step S1214). The details of the HTML content received in Step S1213 (total monetary amount, total size, encrypted product names, purchase identification number), for example, are included in this request.

Controller 67 of web server 65 reads out the content for the input of the name and address information stored in DB 83. Controller 67 incorporates the total monetary amount and encrypted product names contained in the HTML content received in Step S1214 into this content that is read out, and it then sends the content to client terminal 85 in accordance with the SSL encrypted communication system (Step S1215). A window corresponding to the website of shipping company T is newly displayed at client terminal 85 through the web browser (Step S1216).

FIG. 14 is a diagram that illustrates an example of the name and address input screen in this embodiment. The purchase total (including tax), the encrypted product names, name and address input boxes, as well as a button that indicates the desire to have the products shipped and a button that rejects shipping, are established on this screen.

Using input operation unit 27, the customer inputs the addressee name and address (Step S1217) and presses the shipping button (Step S1218). In accordance with the SSL encrypted communication system, client terminal 85 sends the name and address inputted in Step S1217 to web server 65 (Step S1219).

Controller 67 of web server 65 encrypts the name and address supplied from client terminal 85 with a public key unique to web server 65 that is stored in DB 83. Furthermore, controller 67 registers the details of the current shipping receipt event to the shipping table stored in DB 83 (Step S1220).

Next, transmission/reception unit 73 of web server 65 establishes SSL encrypted communication with web server 45 in response to the instruction of controller 67. This communication is established with the same procedures as described after Step S1213, with the exception that web server 45 takes the place of the previous client terminal 85.

In response to the commencement of SSL encrypted communication, controller 67 of web server 65 notifies web server 45 of the shipping receipt results in accordance with the SSL encrypted communication system (Step S1221). In addition to the actual receipt result (for example, “OK/NO,” etc.), the product shipping number previously registered in the shipping table, the encrypted addressee name and address, and the purchase identification number are included in these receipt results.

Web server 45 forwards the receipt results supplied from web server 65 to client terminal 85 (Step S1222). Client terminal 85 displays the receipt results in a window corresponding to website W (Step S1223). Controller 67 then terminates SSL encrypted communication.

After this, controller 47 of web server 45 refers to the purchase table of DB 63 and decrypts the encrypted product names corresponding to the purchase identification number contained in the receipt results notified in Step S1221 with the private key unique to web server 45 that is stored in DB 63.

Through this decryption, the corresponding products are packaged, and after labels indicating the product shipping number, the encrypted product names, and the encrypted addressee name and address have been attached, they are delivered to shipping company T (Step S1224).

At the website of shipping company T, the encrypted addressee name and address shown on the received product labels are inputted through input operation unit 69. Controller 67 obtains the name and address by decrypting the inputted encrypted name and address with the private key unique to web server 65, which is stored in DB 83 of web server 65.

Next, shipping company T ships the products to the location of the obtained name and address (Step S1225). For example, in the case in which a payment-on-delivery system is used, shipping company T charges the customer for the price of the products when the products are delivered (Step S1226). The customer pays the price charged by shipping company T (Step S1227). In response to the customer's payment of the cost of the products, shipping company T pays the individual or corporation that administers shopping mall website W (Step S1228).

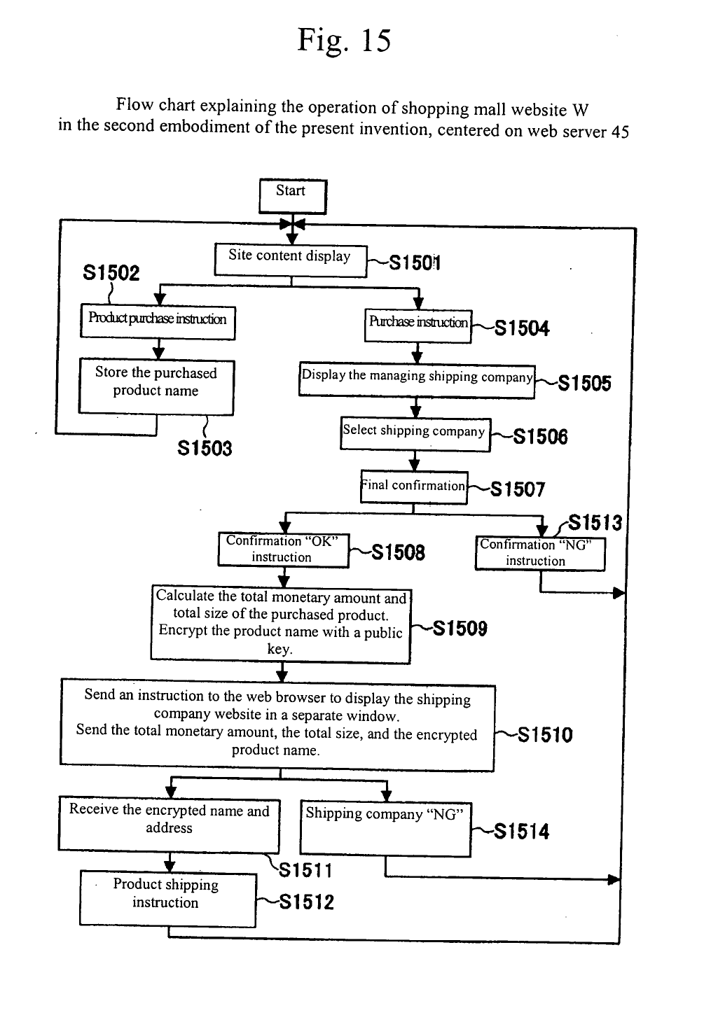

FIG. 15 is a flow chart that explains the operation of shopping mall website W in this embodiment, centered on web server 45. Here, the link with the web browser of client terminal 85 or web server 65 will be explained.

First, product information (refer to FIG. 4) is provided to client terminal 85 by web server 45 and displayed (Step S1501). Next, in sequential response to the selection of desired products (Step S1502), the selected product names are stored in RAM 59 (Step S1503).

Next, when the request for settlement is received (Step S1504), shipping company information is read out and sent to client terminal 85. Through this, the shipping company information (refer to FIG. 5) is displayed at client terminal 85 (Step S1505).

Next, when a shipping company is selected at client terminal 85 (Step S1506), a small window separate from the window shown in FIG. 5 is displayed, for example, and the advisability of the selection is finally confirmed (Step S1507).

In the final confirmation, when a confirmed “OK” instruction is received from client terminal 85 (Step S1508), the product catalog is consulted, the prices shown corresponding to the product names stored in Step S1503 are totaled, and the total monetary amount of the products purchased is calculated.

Moreover, the product catalog is consulted and the product sizes shown in correspondence with the product names stored in Step S1503 are totaled, and the total size of the purchased products is calculated. Furthermore, the product names stored in Step S1503 are decrypted with the public key unique to web server 45 (Step S1509).

A purchase identification number is then issued, and this purchase identification number and the product names encrypted in Step S1510 are handled and registered in the purchase table. Moreover, when a confirmed “NG”—in other words, an instruction to cancel—is received from client terminal 85 (Step S1513), the system returns to Step S1501.

Next, an instruction that causes the website of shipping company T that was selected in Step S1506 to be displayed in a separate window is sent to client terminal 85.

In this embodiment, this instruction is sent as HTML content containing the total monetary amount and total size calculated in Step S1509, the product names encrypted in Step S1509, and the purchase identification number (refer to FIG. 13) (Step S1510).

Next, in the case in which SSL encrypted communication is established with web server 85 of the website of shipping company T, a notification regarding the receipt of the shipment is received. The purchase identification number is obtained from these received receipt results (Step S1511). For example, the products corresponding to the obtained purchase identification number are delivered to shipping company T (Step S1512). Moreover, in the case in which SSL encrypted communication is not established (Step S1514), the system returns to Step S1501.

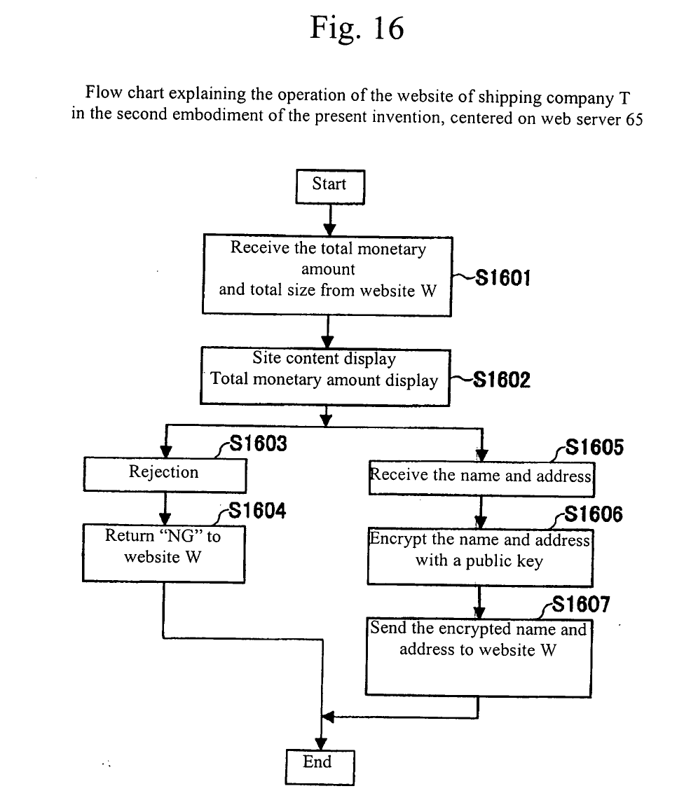

FIG. 16 is a flow chart that explains the operation of the website of shipping company T in this embodiment, centered on web server 65. Here, the link with the web browser of client terminal 85 or web server 45 will be explained.

First, after SSL encrypted communication has been established, the total monetary amount, the total size, the encrypted product names, and the purchase identification number are received from client terminal 85 (Step S1601). In response to this reception, the content of the name and address input screen shown in FIG. 14 is created, and this is displayed at client terminal 85 (Step S1602).

Next, when the button that rejects shipping (refer to FIG. 14) is pressed—in other words, when the execution of shipping receipt processing is rejected by the customer (Step S1603)—a message indicating “NG” is sent to web server 45 of website W, and SSL encrypted communication is terminated (Step S1604). Moreover, when the button that instructs the shipment of the products (refer to FIG. 14) is pressed, the addressee name and address are received (Step S1605). Next, the name and address received in Step S1605 are encrypted with the public key unique to web server 65 (Step S1606). Furthermore, the details of the current receipt event are registered in the shipping table.

SSL encrypted conmmununication is then established with web server 45, and information such as the product shipping number is sent along with the receipt results (Step S1507).

To summarize the system in this embodiment, web server 45 has, in particular, DB 63, controller 47, and transmission/reception unit 53. DB 63 stores the encryption key that is unique to shopping mall website W, as well as the names, sizes, and prices of the products provided at this website W. Transmission/reception unit 53 receives a request for settlement regarding the purchase of products from client terminal 85.

Controller 47 refers to DB 63 and computes the total monetary amount and total size of the purchased products from the product names contained in this settlement request, and it encrypts the product names included in this settlement request with a public key stored in DB 63. Moreover, when a designation of shipping company T is received by transmission/reception unit 53, controller 47 instructs this designated shipping company to perform product shipping receipt processing. In response to the instruction from controller 47, transmission/reception unit 53 sends an instruction to client terminal 85 to connect to the website of the designated shipping company T, this instruction including the encrypted product names, the total monetary amount and total size of the purchased products, and the purchase identifier.

Here, in the aforementioned embodiment, encrypted product names are registered in the DB (purchase table) for every purchase even in correspondence with the purchase identifier (Step S1212 of FIG. 12), and all of this information is sent to client terminal 85 (Step S1213). The purchase table is then consulted at web server 45, and the encrypted names corresponding to the purchase identification number contained in the receipt results from web server 65 are decrypted.

In contrast to this, as another embodiment of this invention, it is of course possible to send only the purchase identification number after registration in the purchase table in Step S1212. It is essential that it be impossible to determine the correspondence of this purchase identification number with the information related to products from the web server 65 side. Therefore, as a special case, the actual encrypted product names may be sent in place of this purchase identification number. In this case, taking into consideration subsequent decryption processing, it is preferable for web server 45 to be aware in advance of the data positions of the encrypted product names in the details of the settlement results received in Step S1221.

In any case, it should be possible to determine the purchase event to which the received settlement results correspond from the web server 45 side. Therefore, an identifier (for example, a symbol string) that identifies the purchase of the product should be stored in the purchase table in accordance with the product selected through client terminal 85.

Moreover, the number of products purchased does not restrict the present invention. Therefore, controller 47 of web server 45 calculates the payment amounts for 1 or multiple products selected through client terminal 85. In accordance with this, controller 47 calculates the necessary volume corresponding to 1 or multiple products.

To further summarize the system in this embodiment, web server 65 has, in particular, DB 83, transmission/reception unit 73, and controller 67. DB 83 stores the encryption key that is unique to the website of transmission company T. Transmission/reception unit 73 receives the product names encrypted with the encryption key that is unique to on the online shopping website W, the total monetary amount and total size of the purchased products, the purchase identification number, and the name and address of the purchaser from client terminal 43.

Controller 67 issues a product shipping number and performs receipt processing by registering the total monetary amount and total size of the purchased products and the addressee name and address received by transmission/reception unit 73. Moreover, controller 67 encrypts the addressee name and address received by transmission/reception unit 73 with the public key stored in DB 83. Transmission/reception unit 73 sends receipt results including the encrypted product names, the purchase identification number, the encrypted addressee name and address, and the product shipping number to online shopping website W.

Combining this with the other embodiment with respect to web server 45 described above, instead of encrypted product names, transmission/reception unit 73 may receive identifiers that identify the purchase of products coordinated with products selected through client terminal 85.

Moreover, in the aforementioned embodiment, the encrypted addressee name and address (and purchase identification number) are registered in DB 83 (shipping table) for every receipt event in correspondence with the product shipping number (Step S1220 in FIG. 12), and both this product shipping number and the encrypted name and address are sent to web server 45 (Step S1221 in FIG. 12). The shipping table is then consulted at web server 65, and the encrypted name and address corresponding to the product shipping number shown on the labels of the products sent from web server 45 are decrypted.

In contrast to this, as another embodiment of this invention, it is of course possible to send only the product shipping number after registration in the shipping table in Step S1220. It is essential that it be impossible to determine the correspondence of this product shipping number to the customer information (name, address, etc.) from the web server 45 side. Therefore, as a special case, the actual encrypted name and address may be sent in place of this product shipping number.

In any case, it should be possible to determine the shipping receipt event to which a received product corresponds from the web server 65 side. Therefore, an identifier (for example, a symbol string) that identifies the shipping of the products should be stored in the shipping table in accordance with the customer information received in Step S1219.

In this way, the names of the purchased products are encrypted with the public key of web server 45 of website W that has the product information, and it is only possible to break the code with the private key of this site W, so the information is concealed from the website of shipping company T. Moreover, the name and address of the purchaser of the products are encrypted with the public key of web server 65 of shipping company T, and it is only possible to break the code with the private key of this site, so the information is concealed from website W. It is therefore possible to perform a series of shipping procedures by obtaining only the information that is necessary for the processing that should be executed at each site.

Moreover, in the aforementioned first and second embodiments, the invention is realized as systems including SSL encrypted communication functionality. The present invention is restricted by SSL encrypted communication.

Furthermore, the anonymous electronic funds transfer system and anonymous shipping system of the present invention are also realized by a program that allows this anonymous electronic funds transfer system and anonymous shipping system to function. This program is, for example, stored on a computer-readable recording medium such as a CD-ROM.

The recording medium that stores the program that allows web server 3 or 45 to function may be the actual ROM 19 or 61 shown in FIG. 2 (FIG. 11), or it may be CD-ROM 15 or 57, which can be read when inserted into a program reading device such as CD-ROM driver 13 or 55, which is established as an external storage device.

Likewise, the recording medium that stores the program that allows web server 23 (65) to function may be the actual ROM 39 (81) shown in FIG. 2 (FIG. 11), or it may be CD-ROM 35 (77), which can be read when inserted into a program reading device such as CD-ROM driver 33 (75), which is established as an external storage device. Moreover, the aforementioned storage mediums may be magnetic tapes, cassette tapes, floppy (registered trademark) disks, hard disks, MO/MD/DVD's, or semiconductor memory.

### Explanation of Symbols

1: certificate authority (CA)

3, 45: shopping mall web servers

5, 25, 47: controllers

7, 27, 49: input operation units

9, 29, 51: display units

11, 31, 53: transmission/reception units

13, 33, 55: CD-ROM drivers

15, 35, 57: CD-ROM

17, 37, 59: RAM

19, 39, 61: ROM

21, 41, 63: databases

23: web server of credit company C

65: web server of shipping company T

43, 85: client terminals

What is claimed is:

1. A shopping mall server in an anonymous electronic funds transfer system, comprising:
a reception unit operable to receive information about a product selected at a client terminal;
a storage unit operable to store a monetary amount of a product provided on an online shopping website, and to store a purchase identifier that identifies a purchase of the product selected at the client terminal;
a computing unit operable to calculate a payment sum for the product selected at the client terminal based on the monetary amount of the product stored in the storage unit, and;
a transmission unit operable to, in response to designation of a credit company, send instructions to connect to a website of the designated credit company to the client terminal, the instructions including the purchase identifier and the payment sum;
wherein the purchase identifier comprises a product name formed by encrypting a name of the product selected at the client terminal with a public key that is unique to the online shopping website.

2. A shopping mall server according to claim 1, wherein the reception unit is further operable to receive settlement results including the purchase identifier from the website of the designated credit company.

3. A credit company server in an anonymous electronic funds transfer system, comprising:
a reception unit operable to receive from a client terminal a payment sum, a purchase identifier that identifies a purchase of a product, and information specifying a credit card;
a storage unit operable to store information specifying a credit card and a usage balance for the credit card corresponding to a customer, and to store a settlement identifier that identifies a settlement regarding the purchase of the product, the settlement associated with the customer having the information specifying the credit card received by the reception unit;
a settlement unit operable to perform settlement and generated settlement results by selecting the credit card specified by the information received by the reception unit from among credit cards stored in the storage unit and comparing the selected usage balance with the payment sum received by the reception unit, and;
a transmission unit operable to send the settlement results generated by the settlement unit, including the purchase identifier and the settlement identifier, to a shopping mall server that issued the purchase identifier;
wherein the purchase identifier is a product name formed by encrypting a name of the product selected at the client terminal with a public key that is unique to the online shopping website.

4. The credit company server according to claim 3, wherein the settlement identifier is a customer name formed by encrypting a customer name corresponding to the information specifying the credit card supplied from the client terminal with a public key that is unique to the website of the credit company.

5. The credit company server according to claim 4, wherein:
the settlement unit is further operable to compare a password supplied from said client terminal with passwords stored in the storage unit to generate a comparison result, and;
the transmission unit is further operable to send the comparison result to the client terminal.

6. A shopping mall server in an anonymous electronic funds transfer system, comprising:
a reception unit operable to receive information about a product selected at a client terminal;
a storage unit operable to store a monetary amount and a size of the selected product, and to store a purchase identifier that identifies a purchase of the selected product;
a computing unit operable to calculate a payment sum and shipping volume for the selected product based on the monetary amount and size of the product stored in the storage unit, and;
a transmission unit operable to send instructions to connect to a website of a designated credit company, the instructions including the purchase identifier, the payment sum, and the shipping volume to the client terminal, in response to designation of a shipping company;
wherein the purchase identifier is a product name formed by encrypting a name of the selected product with a public key that is unique to the online shopping website.

7. The shopping mall server according to claim 6, wherein the reception unit is further operable to receive shipping receipt results including the purchase identifier from a website of the designated shipping company.

8. A shipping company server in an anonymous electronic funds transfer system, comprising:
a reception unit operable to receive a purchase identifier that identifies a purchase of a product, a payment sum and shipping volume relating to the product, and customer information relating to a purchaser of the product, from a client terminal;
a storage unit operable to store a shipping identifier that identifies a shipment of the product, and;
a transmission unit operable to send shipping reception results, including the purchase identifier and the shipping identifier, to a shopping mall server that issued the purchase identifier;
wherein the purchase identifier is a product name formed by encrypting the name of the product selected at the client terminal with a public key that is unique to the online shopping website.

9. The shipping company server according to claim 8, wherein the settlement identifier is a customer name formed by encrypting a customer name included in the customer information with a public key that is unique to a website of a credit company.

10. An anonymous electronic funds transfer method comprising the steps of:
receiving information about a product selected at a client terminal;
storing a monetary amount of the selected product provided by an online shopping website;
storing a purchase identifier that identifies a purchase of the selected product;
calculating a payment sum for the selected based on the stored monetary amount of the selected product, and;
sending, in response to designation of a credit company, instructions to connect to a website of the designated credit company, the instructions including the purchase identifier and the payment sum, to said client terminal.

11. The anonymous electronic funds transfer method according to claim 10, further comprising the step of:
encrypting a name of the selected product with a public key that is unique to the online shopping website to form a product name included in the purchase identifier.

12. The anonymous electronic funds transfer method according to claim 11, further comprising the step of:
receiving settlement results including the purchase identifier from the website of the designated credit company.

13. An anonymous electronic funds transfer method comprising the steps of:
receiving from a client terminal a payment sum, a purchase identifier that identifies a purchase of a product, and information specifying a credit card;
storing information specifying a credit card and a usage balance for the credit card corresponding to a customer;
storing a settlement identifier that identifies a settlement regarding the purchase of the product, the settlement associated with the customer having the information specifying the credit card;
performing settlement and generating settlement results by selecting the credit card specified by the information received by the reception unit from among credit cards stored in the storage unit and comparing the selected usage balance with the payment sum received by the reception unit, and;
sending the settlement results generated by the settlement unit, including the purchase identifier and the settlement identifier, to a shopping mall server that issued the purchase identifier.

14. The anonymous electronic funds transfer method of claim 13, further comprising the step of:
encrypting a name of the product selected at the client terminal with a public key that is unique to the online shopping website to form a product name included in the purchase identifier.

15. The anonymous electronic funds transfer method of claim 14, further comprising the step of: encrypting a customer name corresponding to the information specifying the credit card supplied from the client terminal with a public key that is unique to the website of the credit company to form a customer name included in the settlement identifier.

16. The anonymous electronic funds transfer method of claim 15, further comprising the step of:
comparing a password supplied from said client terminal with passwords stored in the storage unit to generate a comparison result, and;
sending the comparison result to the client terminal.

17. An anonymous electronic shipping method comprising the steps of:
receiving information about a product selected at a client terminal;
storing a monetary amount and a size of a product provided on an online shopping website;
storing a purchase identifier that identifies a purchase of the selected product;
calculating a payment sum and a shipping volume for the selected product based on the stored monetary amount and the stored size of the product; and
sending, in response to designation of a shipping company, instructions to connect to a website of the designated shipping company to the client terminal, the instructions including the purchase identifier, the payment sum and the shipping volume.

18. The anonymous electronic shipping method according to claim 17, further comprising the step of:
encrypting a name of the selected product with a public key that is unique to the online shopping website to form a product name included in the purchase identifier.

19. The anonymous electronic shipping method according to claim 18, further comprising the step of:
receiving shipping receipt results including the purchase identifier from a website of the designated shipping company.

20. An anonymous shipping method comprising the steps of:
receiving a purchase identifier that identifies a purchase of a product, a payment sum and shipping volume relating to the product, and customer information relating to a purchaser of the product, from a client terminal;
storing a shipping identifier that identifies a shipment of the product; and
sending shipping reception results, including the purchase identifier and the shipping identifier, to a shopping mall server that issued the purchase identifier.

21. The anonymous shipping method according to step 20, further comprising the step of:
encrypting the name of the product selected at the client terminal with a public key that is unique to the online shopping website for form a product name included in the purchase identifier.

22. The anonymous shipping method according to step 21, further comprising the step of:
encrypting a customer name included in the customer information with a public key that is unique to a website of a credit company to form a customer name included in the settlement identifier.
